(19) United States
(12) Patent Application Publication
(10) Pub. No.: US 2013/0061402 A1
(43) Pub. Date: Mar. 14, 2013

(54) MULTIPURPOSE DETERGENT COMPOSITIONS

(71) Applicants: Gayle Marie FRANKENBACH, Cincinnati, OH (US); Eugene Joseph Pancheri, Montogmery, OH (US); Jan Richard Davis, Harlan Township, OH (US); Seok Kwon, Singapore (SG)

(72) Inventors: Gayle Marie FRANKENBACH, Cincinnati, OH (US); Eugene Joseph Pancheri, Montogmery, OH (US); Jan Richard Davis, Harlan Township, OH (US); Seok Kwon, Singapore (SG)

(21) Appl. No.: 13/414,067

(22) Filed: Mar. 7, 2012

Related U.S. Application Data
(60) Provisional application No. 61/449,895, filed on Mar. 7, 2011.

(51) Int. Cl. C11D 1/04; D06L 1/16

(52) U.S. Cl. 8/137; 510/405; 510/351; 510/488

(57) ABSTRACT

A multipurpose detergent composition comprising from about 5% to about 25% of a surfactant system comprising: from about 20% to about 100% of at least one anionic surfactant, wherein no more than about 12% by weight of the overall multipurpose detergent composition comprises anionic surfactants having more than 14 carbon atoms; from about 0.04% to about 40% of an ethoxylated nonionic surfactant; and from about 0.5% to about 5% of at least one organic acid, each organic acid in the multipurpose detergent composition having fewer than 9 carbon atoms, whereby the multipurpose detergent composition has a neat pH of from about 2 to about 7; the multipurpose detergent composition is substantially free of cationic surfactants, zwitterionic surfactants, and amphoteric surfactants, enzymes, soil suspension polymers and soil release polymers.

### CROSS-REFERENCES TO RELATED APPLICATIONS

This application claims priority under 35 U.S.C. §119(e) to U.S. Provisional Application Ser. No. 61/449,895 filed Mar. 7, 2011.

### TECHNICAL FIELD

The present invention relates generally to detergent compositions and, more specifically, to multipurpose detergent compositions suitable for washing of clothes and also suitable for use on hair and skin.

### BACKGROUND

Numerous detergent compositions are available for use by consumers for washing clothing and other fabrics in traditional washing machines. However, in many parts of the world, especially where average household income is as low as US$2 per day and/or available water supply are limited, traditional washing machines remain unaffordable luxury items. In some countries and remote villages, for example, clothing articles typically are washed by hand in a bucket, using available laundry soap bars and powders. The washing by hand may involve rubbing or abrading the clothing articles, such as with a washboard or stone, and the water used for the washing may be exceptionally hard or even polluted. Often, where water is scarce, the same water used to wash the clothing articles will be reused to wash skin and hair of one or more family members.

Typical consumer laundry-detergent compositions are not indicated or generally approved for use on skin and hair. Unlike common body soaps, shampoos, and other toiletry products that are tailored for such applications, consumer detergent compositions usually contain one or more ingredients that will cause skin or eye irritation. The mechanical action used to apply bar soaps and powders to fabrics, skin, and hair, damages all three. The high pH of the powders and the bars also leads to redness, irritation, and transepidermal water loss in skin. Low pH products can also help control malodor on fabrids, skin and hair which provides a health and social benefit to the consumer. Continued use of such products for hand washing laundry and washing the body leads to skin damage which provides routes for disease and reduces the overall health of the consumer.

For example, whereas body-cleansing products usually are formulated so as not to disrupt a proper skin pH balance, consumer laundry-detergent compositions usually are not. To put the problem in perspective, it is known that a newborn baby's skin pH normally has close to a neutral value of 7, and that the presence of disease fighting bacteria on normal human skin even shortly after birth results in a slightly acidic, healthy-skin pH in the range of 4.5 to 6. Typical consumer laundry detergent compositions have pH values ranging from 7 to as high as 11. If the slightly acidic skin is repeatedly exposed to solutions containing such highly alkaline laundry detergent compositions, the skin pH can be raised high enough to kill off most or all of the disease fighting bacteria on the skin, thereby compromising the immune system of the individual. This problem is exacerbated by the tendency of highly alkaline materials to dry the skin and cause cracking, leaving the individual even more vulnerable to infection.

A compromised immune system brought about through the use of harsh laundry detergent compositions as personal care products is especially concerning, owing to the high levels of air pollution present where the practice typically occurs. Exposure of cracked, bacteria-stripped skin to air having high levels of particulates can increase the seriousness of any infection that does occur, because in essence the wound through which the infection enters always is dirty. Any attempt to clean the infection using the same wash water with the same alkaline laundry detergent composition will be unhelpful.

High pH products are traditionally used in laundry because the high pH enables the use of traditional builders, which typically must be deprotonated to sequester calcium and other minerals that reduce the effectiveness of surfactants. However, in addition to being damaging to the skin, the combination of high pH and builder also can result in deposition of builders on fabric, hair, and skin, thereby damaging fabric, hair, and skin and degrading the appearance of each. Yet, low pH approaches are avoided because typical products depend on a combination of builders and soap, which must remain deprotonated to be effective in hard conditions.

Therefore, there remains an ongoing need for multipurpose detergent compositions that are both economical and effective, not only for washing clothing, but also for washing hair and skin without causing irritations or health problems. This need may be embodied in a product that provides superior laundry cleaning and is also mild enough to use on hair and skin.

Further the consumer desires a liquid product that provides a superior cleansing experience. Formulating a liquid product for skin, hair and laundry provides a superior experience because the product can be used to pre-soak clothes which then reduces the amount of work needed to scrub stains from clothes. The liquid also provides a superior cleaning experience because the process of scrubbing is significantly lower than bars and therefore does not damage hair, skin or clothes.

Additionally, the consumer, begin economically challenged, desires to protect product from being wasted, so having a package that is stable to tipping or spilling while storing product and has a small orifice to reduce overusage and spilling is important.

### SUMMARY

The inventors have found that by reducing the pH, it is possible to control hardness of a variety of water sources under concentrated wash conditions, such that synthetic detergents can perform admirably at low levels in cleaning clothes, hair, and body. This provides for a multipurpose detergent composition that is both very economical and high performing, in addition to being mild to the skin, hair, and eyes.

Thus the invention encompasses A multipurpose detergent composition comprising

from about 5% to about 25% by weight, based on the weight of the multipurpose detergent composition, of a surfactant system comprising: from about 20% to about 100% by weight, based on the weight of the surfactant system of at least one anionic surfactant, wherein no more than about 12% by weight of the overall multipurpose detergent composition comprises anionic surfactants having more than 14 carbon atoms; from about 0.04% to about 40% by weight, based on the weight of the surfactant system of an ethoxylated nonionic surfactant; and from about 0.5% to about 5% by weight, based on the weight of the multipurpose detergent composition, of at least one organic acid, each organic acid in the multipurpose detergent composition having fewer than 9 carbon atoms,

whereby the multipurpose detergent composition has a neat pH of from about 2 to about 7; the multipurpose detergent composition is substantially free of cationic surfactants, zwitterionic surfactants, and amphoteric surfactants; the multipurpose detergent composition is substantially free of enzymes; and the multipurpose detergent composition if substantially free of soil suspension polymers and soil release polymers.

The invention further encompasses a multipurpose detergent composition as above, wherein each organic acid in the multipurpose detergent composition has fewer than 6 carbon atoms.

The invention further encompasses a multipurpose detergent composition as above, wherein the multipurpose detergent composition comprises from 20% to 80% by weight, based on the weight of the multipurpose detergent composition, of the at least one anionic surfactant.

The invention further encompasses a multipurpose detergent composition as above, wherein the surfactant system further comprises at least one nonionic surfactant.

The invention further encompasses a multipurpose detergent composition as above, comprising from 0.01% to 4.0% by weight, based on the weight of the multipurpose detergent composition, of the at least one nonionic surfactant.

The invention further encompasses a multipurpose detergent composition as above, wherein the surfactant system consists essentially of a linear alkyl benzene sulfonic acid and a C₁₂-C₁₈ alkyl ethoxylate.

The invention further encompasses a multipurpose detergent composition as above, wherein the linear alkyl benzene sulfonic acid is a C11.8 linear alkyl benzene sulfonic acid.

The invention further encompasses a multipurpose detergent composition as above, wherein the surfactant system consists essentially of ethoxylated laureth sulfate or lauryl sulfate or combinations thereof.

The invention further encompasses a multipurpose detergent composition as above, wherein the at least one organic acid comprises acetic acid, lactic acid, formic acid, or mixtures thereof.

The invention further encompasses a multipurpose detergent composition as above, wherein the multipurpose detergent composition has a transmittance of at least 5% at 500 nm.

The invention further encompasses a multipurpose detergent composition as above, wherein the multipurpose detergent composition has an eye irritation value of at least 0.5 mg/mL, comparable to marketed shampoo products which would be.

The invention further encompasses a multipurpose detergent composition as above, wherein the multipurpose detergent composition has an eye irritation value comparable to marketed shampoo products which would be at least 0.6 mg/mL

The invention further encompasses a multipurpose detergent composition as above, wherein the multipurpose detergent composition has a lathering index to a high-lather control of at least 50%.

The invention further encompasses a multipurpose detergent composition as above, wherein the detergent composition is a liquid multipurpose detergent composition having a viscosity of from about 1 to about50000 mPa·s.

The invention further encompasses a multipurpose detergent composition as above, wherein the composition is capable of providing a wash water pH, when added to the wash water, of less than 7.

The invention further encompasses a multipurpose detergent composition as above, wherein the composition is capable of providing a wash water pH, when added to the wash water, of less than 7.

The invention further encompasses a multipurpose detergent composition as above, wherein the composition has a pH of less than 6.5 when diluted by about 700%.

The invention further encompasses a multipurpose detergent composition as above, wherein the composition is substantially free of fatty acid compounds.

The invention further encompasses an combination of a multipurpose detergent having a viscosity of about 50 cps to 5000 cps with a container having a orifice with a diameter of from about 2 to 4.5 mm.

The invention further encompasses a combination of a multipurpose detergent having a viscosity of about 2000 cps to 5000 cps with a container having an orifice with a diameter of from about 4 to about to 6 mm.

The invention further encompasses a method of laundering fabrics which provides reduction of fabric dinginess. The method comprises introducing a multipurpose detergent composition as above into a wash water in an amount sufficient to generate a pH of from about 5 to about 7 in the wash water.

The invention further encompasses the method as above, wherein after the detergent composition is introduced into the wash water, the wash water comprises from about 0.02% to about 4.0%, by weight of the wash water, of the detergent composition.

### DETAILED DESCRIPTION

The components of multipurpose detergent compositions herein, as well as composition form, preparation, and use, are described in greater detail as follows:

In this description, all concentrations and ratios are on a weight basis of the multipurpose detergent composition unless otherwise specified. Elemental compositions such as percentage nitrogen (% N) are percentages by weight.

Molecular weights of polymers are number average molecular weights unless otherwise specifically indicated.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included.

Particle size ranges are ranges of median particle size. For example a particle size range of from 0.1 μm to 200 μm refers to the median particle size having a lower bound of 0.1 μm and an upper bound of 200 μm.

Particle size may be measured known techniques such as a laser-scattering technique, using a Coulter LS 230 Laser Diffraction Particle Size Analyzer from Coulter Corporation, Miami, Fla., 33196, USA.

All documents cited herein are, in relevant part, incorporated herein by reference. The citation of any document is not to be considered as an admission that it is prior art with respect to the present invention.

All measurements referenced herein are at room temperature (about 21.1° C.) and at atmospheric pressure, unless otherwise indicated.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages, parts and ratios are based upon the total weight of the multipurpose detergent compositions, unless otherwise specified. All such weights as they pertain to listed ingredients exclude carriers, diluents etc. that may occur in commercial forms of the materials, unless otherwise specified.

A multipurpose detergent composition according to the present invention for providing both superior cleaning and mildness to skin, hair, and eyes, may comprise a surfactant system and at least one organic acid. The surfactant system may comprise at least one anionic surfactant.

### Multipurpose Detergent Composition

The multipurpose detergent compositions of the present invention may be in liquid form, including a gel form. In one specific embodiment, the compositions are liquid in form and comprise heavy duty liquid compositions.

The multipurpose detergent compositions contain a surfactant, and have a pH of at least 2.0 and when added to wash water, provide a pH of less than about 6.5. The multipurpose compositions are described in further detail below.

### Surfactant Component

The multipurpose detergent composition comprises a surfactant system in an amount sufficient to provide desired cleaning properties. In one embodiment, the multipurpose detergent composition comprises, by weight of the composition, from about 5% to about 25% of the surfactant system, and more specifically from about 5% to about 20% of the surfactant system, and more specifically from about 5% to about 15% of the surfactant system, and even more specifically from about 10% to about 15% of the surfactant system. In a specific embodiment, the surfactant system comprises anionic surfactant, nonionic surfactant, or mixtures thereof. In another embodiment, the surfactant system may comprise anionic surfactant, nonionic surfactant, or mixtures thereof, Preferably, the surfactant system comprises anionic surfactant, nonionic surfactant, or mixtures thereof and is substantially free of cationic surfactants, zwitterionic surfactants, and amphoteric surfactants. As used herein, “substantially free of cationic surfactants, zwitterionic surfactants, and amphoteric surfactants” means that none of these ingredients is intentionally added to the multipurpose detergent composition but may be present as trace impurities, for example.

The surfactant system of the present invention is substantially free of alkylethoxylates (AES) and fatty carboxylates (fatty acids or salts).

### Anionic Surfactant

The surfactant system of the multipurpose detergent composition includes at least one anionic surfactant. In further embodiments, the surfactant system may consist essentially of, or even consist of anionic surfactant. The surfactant system may comprise, by weight of the surfactant system, from about 20% to about100% of the at least one anionic surfactant, and more specifically from about 20% to about 80% of the at least one anionic surfactant, and more specifically from about 20% to about 60% of the at least one anionic surfactant, and even more specifically from about 40% to about 60% of the at least one anionic surfactant. Additionally, regardless of the types of anionic surfactant and the amounts thereof in the multipurpose detergent composition, for an effective cleaning profile the multipurpose detergent composition comprises less than 12% by weight, based on the weight of the composition, of any one, or more than one, anionic surfactant having greater than 14 carbon atoms.

Specific, non-limiting examples of suitable anionic surfactants include the alkyl benzene sulfonic acids and their salts.

Examples of anionic surfactants include the alkali metal salts of C₁₀₋₁₆ alkyl benzene sulfonic acids, preferably C₁₁₋₁₄ alkyl benzene sulfonic acids. Preferably the alkyl group is linear and such linear alkyl benzene sulfonates are known as “LAS.” Alkyl benzene sulfonates, and particularly LAS, are well known in the art. Such surfactants and their preparation are described for example in U.S. Pat. Nos. 2,220,099 and 2,477,383. In one embodiment, the alkyl benzene sulfonates surfactant is selected from sodium and potassium linear straight chain alkylbenzene sulfonates in which the average number of carbon atoms in the alkyl group is from about 11 to 14. Sodium C₁₁-C₁₄, for example, C₁₂, LAS is a specific example of such surfactants.

Generally speaking, anionic surfactants useful herein are disclosed in U.S. Pat. No. 4,285,841, Barrat et al., issued Aug. 25, 1981, and in U.S. Pat. No. 3,919,678, Laughlin, et al., issued Dec. 30, 1975.

Useful anionic surfactants also include the water-soluble salts, particularly the alkali metal, ammonium and alkylolammonium (e.g., monoethanolammonium or triethanolammonium) salts, of organic sulfuric reaction products having in their molecular structure an alkyl group containing from about 10 to about 20 carbon atoms and a sulfonic acid group. (Included in the term “alkyl” is the alkyl portion of aryl groups.) Other anionic surfactants useful herein are the water-soluble salts of: paraffin sulfonates and secondary alkane sulfonates containing from about 8 to about 24 (preferably about 12 to 18) carbon atoms; alkyl glyceryl ether sulfonates, especially those ethers of C₈₋₁₈ alcohols (e.g., those derived from tallow and coconut oil).

Mixtures of the alkylbenzene sulfonates with the above-described paraffin sulfonates, secondary alkane sulfonates and alkyl glyceryl ether sulfonates are also useful.

### Nonionic Surfactant

In addition to the anionic surfactant component, the surfactant system of the multipurpose detergent compositions of the present invention may further contain an ethoxylated nonionic surfactant. The surfactant system may contain up to about 40%, in one embodiment from about 0.04% to about 40%, alternatively from about 0.4% to about 40%, by weight of the surfactant system, of an ethoxylated nonionic surfactant. In preferred embodiments, the multipurpose detergent compositions may comprise from about 0.04% to about 20%, or from about 0.04% to about 16%, by weight of the composition, of the ethoxylated nonionic surfactant. These materials are described in U.S. Pat. No. 4,285,841, Barrat et al, issued Aug. 25, 1981. In one embodiment, the nonionic surfactant is selected from the ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. These surfactants are more fully described in U.S. Pat. No. 4,284,532, Leikhim et al, issued Aug. 18, 1981. In one embodiment, the nonionic surfactant is selected from ethoxylated alcohols having an average of from about 10 to about 15 carbon atoms in the alcohol and an average degree of ethoxylation of from about 3 to about 12 moles of ethylene oxide per mole of alcohol.

Without being limited by theory, it is believed that the addition of an ethoxylated nonionic surfactant to the detergent compositions of the invention herein is helpful in providing physical stability to the detergent product, i.e., preventing phase splits and precipitation. This is particularly true for compositions containing low levels of anionic surfactant. Therefore, one embodiment of the invention herein comprises at least about 0.1%, by weight of the detergent composition, of the nonionic surfactant in the detergent compositions herein. Without intent to be bound by theory, it is believed also that the presence of alkyl ethoxylate nonionic surfactants in a multipurpose detergent composition can reduce the irritancy commonly associated with anionic surfactants. This irritancy reduction becomes especially advantageous in view of the multipurpose detergent compositions being used as shampoos, not just as laundry detergents.

Suitable nonionic surfactants useful herein can comprise any of the conventional nonionic surfactant types typically used in liquid and/or solid detergent products. These include alkoxylated fatty alcohols and amine oxide surfactants. Preferred for use in the liquid detergent products herein are those nonionic surfactants which are normally liquid.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, alternatively from about 3 to 10 ethylene oxide moieties per molecule.

The alkoxylated fatty alcohol materials useful in the detergent compositions herein will frequently have a hydrophilic-lipophilic balance (HLB) which ranges from about 3 to 17. In one embodiment, the HLB of this material will range from about 6 to 15, alternatively from about 8 to 15. Alkoxylated fatty alcohol nonionic surfactants have been marketed under the tradenames Neodol and Dobanol by the Shell Chemical Company.

Non-limiting examples of nonionic surfactants useful herein include: C₁₂-C₁₈ alkyl ethoxylates, such as, NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as discussed in U.S. Pat. No. 6,150,322; C₁₄-C₂₂ mid-chain branched alkyl alkoxylates, BAEₓ, wherein x is from 1 to 30, as discussed in U.S. Pat. No. 6,153,577, U.S. Pat. No. 6,020,303 and U.S. Pat. No. 6,093,856; Alkylpolysaccharides as discussed in U.S. Pat. No. 4,565,647 to Llenado, issued Jan. 26, 1986; specifically alkylpolyglycosides as discussed in U.S. Pat. No. 4,483,780 and U.S. Pat. No. 4,483,779; Polyhydroxy fatty acid amides as discussed in U.S. Pat. No. 5,332,528, WO 92/06162, WO 93/19146, WO 93/19038, and WO 94/09099; and ether capped poly(oxyalkylated) alcohol surfactants as discussed in U.S. Pat. No. 6,482,994 and WO 01/42408.

The multipurpose detergent compositions that do comprise one or more nonionic surfactants preferably are substantially free of amine oxide surfactants, betaines, and sulfobetaines, which materials often are referred to in the art as “semi-polar” nonionics or “zwitterionic” surfactants. Amine oxides have the formula: R(EO)ₓ(PO)_{y}(BO)_{z}N(O)(CH₂R′)₂.qH₂O. In this formula, R is a relatively long-chain hydrocarbyl moiety which can be saturated or unsaturated, linear or branched, and can contain from 8 to 20, in one embodiment from 10 to 16 carbon atoms, and is alternatively a C₁₂-C₁₆ primary alkyl. R′ is a short-chain moiety, and may be selected from hydrogen, methyl and —CH₂OH. When x+y+z is different from 0, EO is ethyleneoxy, PO is propyleneoxy and BO is butyleneoxy. Amine oxide surfactants are illustrated by C₁₂₋₁₄ alkyldimethyl amine oxide. Without intent to be bound by theory, it is believed that zwitterionic surfactants in the multipurpose detergent compositions, despite their recognized advantages for increasing sudsing, may result in formation of precipitants and may require additional rinsing of fabrics, skin, and hair. Additional rinsing is particularly undesirable in economically disadvantaged areas where water supply is low.

### Anionic/Nonionic Combinations

In the multipurpose detergent compositions herein, the surfactant component may comprise combinations of anionic and nonionic surfactant materials. When this is the case, the weight ratio of anionic to nonionic will typically range from 10:90 to 95:5, more typically from 30:70 to 70:30.

### Cationic Surfactant

The multipurpose detergent compositions preferably are substantially free of cationic surfactants and surfactants that become cationic below a pH of 7, alternatively below a pH of 6. Cationic surfactants are known to form precipitates with anionic surfactants. The presence of cationic-anionic surfactant precipitate is evident in the formation of turbid/cloudy (not clear) formulations that physically separate. To stabilize these formulations it is necessary to reduce anionic surfactant and to increase nonionic surfactant to control separation of the cationic-anionic surfactant precipitates.

### Organic Acid

The multipurpose detergent compositions contain at least one organic acid, preferably in the form of an organic carboxylic acid or polycarboxylic acid. Examples of organic acids that may be used include: lactic acid, acetic acid, adipic acid, aspartic acid, carboxymethyloxymalonic acid, carboxymethyloxysuccinic acid, citric acid, glutaric acid, hydroxyethyliminodiacetic acid, iminodiacetic acid, maleic acid, malic acid, malonic acid, oxydiacetic acid, oxydisuccinic acid, succinic acid, sulfamic acid, tartaric acid, tartaric-disuccinic acid, and tartaric-monosuccinic acid. Particularly preferred are acids that can also serve as detergent builders such as citric acid. The multipurpose detergent composition of the present invention contains from about 0.1% to about 5%, alternatively from about 0.1% to about 4%, alternatively from about 0.1 to about 3%, by weight of the composition, of the organic acid source. In one embodiment the multipurpose detergent composition contains from about 0.5% to about 5%, alternatively from about 1% to about 5%, alternatively from about 1% to about 3%, by weight of the composition, of the organic acid.

In some non-limiting example embodiments, each organic acid may be a low-weight acid, for example, an acid having a molecular weight of less than 150 g/mole. In preferred embodiments, each organic acid in the multipurpose detergent composition has fewer than 9 carbon atoms, alternatively fewer than 6 carbon atoms. In further preferred embodiments, each organic acid in the multipurpose detergent composition may have fewer than 4 carbon atoms or fewer than 3 carbon atoms. Specific examples of organic acids having fewer than 3 carbon atoms include, but are not limited to, formic acid and acetic acid.

The at least one organic acid in the multipurpose detergent composition may prevent calcium in typical wash water from precipitating surfactants and salts that interfere with cleaning properties of surfactants and cleaning of surfaces and soils. Calcium tends to bind soils to each other and surfaces and the most commonly observed example of this is the formation of calcium soap that tends to “lock” gray soils onto surfaces by blocking surfactancy. However, calcium and other multidentate cations also cause surfactants to precipitate in hard water. So calcium precipitation has a detrimental effect on both soil and surfactants that reduces cleaning efficacy. Blocking calcium precipitation in the wash water solution improves grease-cutting performance of the surfactant system. Improved grease-cutting performance is advantageous both for washing fabrics and for washing skin and hair. Additionally, preventing calcium precipitation enables the surfactant system to provide adequate foaming. For example, a 2% solution of the multipurpose detergent compositions at 30 C and in the presence of 100 ppm CaCO₃ may generate a foam height of greater than 140 mm after 5 minutes. Characterization of foam height is described in further detail below.

Additionally, high levels of calcium in wash water, greater than 10 grains per gallon (180 ppm Ca, based on CaCO₃), for example, is known not only to have deleterious effects on surfactant performance, but also to cause fabrics to have a bumpy feel. It is believed that the bumpy feel to the fabric is caused by fibers forming pills, resulting in a fabric with a higher effective surface area exposed to the air. The greater exposed surface area, in turn, is more likely to become dirty or to appear dingy, particularly in polluted environments. Additionally, in the context of a multipurpose detergent composition appropriate for hair, high levels of calcium in wash water is known to damage hair when the hair is repeatedly washed in the hard water.

As such, the components of the underbuilt, low-surfactant multipurpose detergent composition function synergistically, whereby the prevention of calcium precipitation afforded by the at least one organic acid in turn allows a composition with a low level of surfactant to clean fabric, hair, and skin effectively. The multipurpose detergent composition is further advantageous in that the synergistic chemistry between the surfactant system and the organic acid results in less physical labor on the part of the consumer who is laundering clothes in a bucket. Such a consumer need not subject fabrics to damaging abrading with a laundry bar; rather, simply sloshing the laundry within the bucket may be sufficient to clean the laundry. Less physical labor and mechanical abrading to hair and skin also preserve the health and physical appearance of skin and hair.

### Enzymes

The compositions of the present invention preferably are substantially free of enzymes. As used herein “substantially free of enzymes” means that no enzymes are purposefully added to the formulation, but yet it is understood to one of ordinary skill in the art that trace amounts of enzymes may be present as impurities in other additives. Enzymes are known sensitizers and, therefore may be disadvantageous within a multipurpose detergent product suitable for use on hair and skin in addition to its use on laundry. The correct choice of type and level of surfactant and organic acid, therefore, is important to providing both good cleaning and mild use conditions in the absence of enzymes.

### Soil Suspension Polymers

The compositions of the present invention preferably are substantially free of soil suspension polymers. Soil suspension polymer include, without limitation, PEI ethoxylates, HMDA diquate ethoxylates, sulfonated derivatives, and hydrophobically modified anionic copolymers.

### Soil Release Polymers

The compositions of the present invention preferably are substantially free of soil release polymers, such as PET alkoxylate short block copolymer, anionic derivative, or mixture thereof.

### Fatty Acid Components

The compositions of the present invention may contain less than about 1% of fatty acid components, but preferably, the compositions of the present invention may be substantially free of fatty acid components. As used herein “substantially free of fatty acid components” means that no fatty acid components are purposefully added to the formulation, but yet it is understood to one of ordinary skill in the art that trace amounts of fatty acid components may be present as impurities in other additives.

Examples of fatty acids include linear and branched, saturated and mono- and polyunsaturated carboxylic acids having from 8 to 22 carbon atoms and their salts.

### Other Laundry Adjuncts

The compositions of the present invention may contain one or more additional laundry adjuncts such as chelants, stabilizers, perfumes, thickeners, and other polymers. The compositions typically contain low levels of builders, preferably are substantially free of builders except insofar as the at least one organic acid may function in such a manner. Underbuilt detergent compositions in general may be advantageous both for cost savings and to preserve the ecology, such by minimizing additional water pollution and damage to vegetation where the compositions may be disposed of directly on the ground or into water supplies. It is believed also that underbuilt detergent compositions are milder to the skin and hair, particularly because they lack aggressive salts and crystalline, abrasive materials.

### Chelants

The compositions of the present invention may contain a chelant. Chelants useful herein include DTPA, HEDP, DTPMP, Tiron, dipicolinic acid, and mixtures thereof.

### Perfumes

The compositions of the present invention may contain an acid-stable perfume.

### Composition pH

The pH of the detergent composition (measured neat) will be preferably at least 2, more preferably at least 2.3, and most preferably at least 2.5. The pH of the detergent composition (measured neat) is less than or equal to 6. In one embodiment, the pH of the detergent composition (measured neat) is from about 2 to about 6, alternatively from about 2.5 to about 6.

### pH in Wash Water

The detergent compositions of the present invention are capable of delivering a pH to the wash water (“wash water pH”), when the detergent composition is added to the wash water (e.g., of a standard laundry bucket) is less than 6.5, in one embodiment less than 6.2, alternatively less than 6.0.

In practical terms, the detergent compositions of the present invention are provided to the wash water in a sufficient amount such that the wash water contains from about 0.02 to about 4%, by weight of the wash water, of the detergent composition. In one embodiment, the wash water contains from about 0.03% to about 3%, by weight of the wash water, of the detergent, alternatively from about 0.04% to about 2% (about 400 to about 2000 ppm).

In one embodiment, the composition has a pH of from about 6 or less when diluted with water by about 700 fold.

Additionally, the pH characteristics of the multipurpose detergent composition in wash water may be defined with respect to skin contact. In this manner, a 0.4% w/w solution of the multipurpose detergent composition may be prepared in water. For example, after a human hand is soaked in the solution for 10 minutes, the pH on the skin of the hand should be less than 8. Preferably, after a human hand is soaked in the solution for 5 minutes, the pH on the skin of the hand should be less than 6.5, more preferably less than 5.5.

### Viscosity

The multipurpose detergent compositions have a viscosity in the range of from about 30 to about 12,000 mPa·s (milli Pascal seconds), alternatively in the range of from about 150 to about 5,000 mPa·s. Preferably, the detergent compositions of the present invention have a viscosity in the range of from about 100 to about 1,500 mPa·s, alternatively from about 150 to about 400 mPa·s. The detergent compositions herein may be in the form of a gel, pourable gels, non-pourable gels, or heavy-duty liquids.

“Gel” as used herein includes a shear thinning gel with a pouring viscosity in the range of from 1,000 to 5,000 mPa·s, in one embodiment less than 3,000 mPa·s, alternatively less than 1,500 mPa·s. Gels may include thick liquids. More generally, a thick liquid may be a Newtonian fluid, which does not change its viscosity with the change in flow condition, such as honey or syrup. A different type of liquid gel is shear-thinning, i.e., it is thick under low shear (e.g., at rest) and thin at high flow rates. The rheology of shear-thinning gels is described in more detail in the literature, see for example WO 04\027010A1 Unilever.

Other compositions according to the present invention are pourable gels having a viscosity of at least 1,500 mPa·s but no more than 6,000 mPa·s, in one embodiment no more than 4,000 mPa·s, alternatively no more than 3,000 mPa·s, alternatively no more than 2,000 mPa·s.

Yet other compositions according to the present invention are non-pourable gels having a viscosity of at least 6,000 mPa·s but no more than 12,000 mPa·s, in one embodiment no more than 10,000 mPa·s, alternatively no more than 8,000 mPa·s and especially no more than 7,000 mPa·s.

Preferred liquid or gel form multipurpose detergent compositions herein include heavy-duty liquid laundry detergents for use in the wash cycle of automatic washing-machines and liquid finewash and/or color care detergents; these suitably have the following rheological characteristics: viscosity of no more than 1,500 mPa·s, in one embodiment no more than 1,000 mPa·s, alternatively, no more than 500 mPa·s. Very suitable compositions have viscosity of from 150 to 400 mPa·s and are either Newtonian or shear-thinning.

In these definitions and unless specifically indicated to the contrary, all stated viscosities are those measured at a shear rate of 21 s⁻¹ and at a temperature of 25° C. Viscosity herein can be measured with any suitable viscosity-measuring instrument, e.g., a Carrimed CSL2 Rheometer at a shear rate of 21 s⁻¹.

### Efficacy and Mildness of Multipurpose Compositions

The inventors have found that multipurpose detergent compositions comprising less than 15% total surfactant, preferably compositions comprising at least 8% anionic surfactant and less than 4% nonionic surfactant provide superior cleaning to laundry and additionally are mild to the skin, hair, and eyes when used as personal cleansing products. These advantages are further enhanced in that such compositions contain from 0.5% to 5% by weight of the composition of an efficient, low molecular-weight (for example, less than 150 g/mol) organic acid to aid cleaning and control calcium and water hardness. Thus, the multipurpose detergent compositions provide adequate results for cleaning of laundry and also protect hands, skin, and fabric during both the typical hand washing process of the laundry and the reapplication of the composition as a body wash.

The multipurpose detergent composition is mild to hair and is safe for the eyes when reapplied as a shampoo. The amount of eye irritation of any particular multipurpose detergent composition can be quantified in terms of a test run according to standard methods known to the person of ordinary skill. The resultant eye irritation dosage then can be used as a basis for comparing the multipurpose detergent compositions with other products such as market shampoo products. In typical standard tests, eye irritation is determined by exposing a batch of test cells, ocular cells for example, to a detergent composition and determining through experimentation a dosage of the detergent composition (in units such as mg/mL) at which the metabolic rate of the test cells is cut in half. As such, the higher the dosage value so determined, the less irritating the detergent composition is on the eyes.

In preferred embodiments, to provide cost savings and to prevent damage to skin, hair, and fabric, the multipurpose detergent composition is free of solid builders and surfactants that result in precipitates. The surfactant system itself provides only a low level of surfactant in the composition as a whole. Total surfactant level also contributes to the mildness of the composition as a whole with regard to skin and hair contact. Prevention of calcium precipitation and, thereby, enhanced surfactant performance, may be realized through the appropriate choice of the at least one organic acid and through the acidic pH of the multipurpose detergent composition in wash water. In preferred embodiments, the multipurpose detergent composition have eye irritation dosages, as described above, comparable to market shampoo products. Market shampoo products typically have eye irritation dosages of at least 0.5 mg/mL, alternatively at least 0.6 mg/mL.

### EXAMPLES

In the following Examples, unless otherwise indicated, the ingredients within the multipurpose detergent compositions are expressed as weight percentages, based on the total weight of the total compositions.

### Determination of Foam Height

To determine the ability of a detergent composition to produce lather, the volume of foam obtained under specific experimental conditions is determined A pipette is constructed from standard-wall chemically-resistant glass tubing having a bulb dimension of 45.0±1.5 mm inside diameter and a lower stem having a 7.0±0.5 mm outside diameter. An upper stem is constructed to contain a solid-stopper, straight bore, No. 2, standard-taper stopcock having a 2-mm bore and stems 8 mm in outside diameter. Both the upper and lower seals of the bulb to the stems are of hemispherical shape. The lower stem is 60±2 mm in length from the point of attachment to the bulb and has an orifice sealed into the lower end. The orifice is constructed from precision bore tubing having an inside diameter of 2.90±0.02 mm and a length of 10.00±0.05 mm, with both ends ground square. The orifice has an outside diameter so as to fit snugly into the lower stem and form a secure seal to the stem when heated with a sharp, pointed flame in a blow torch. The pipette is calibrated to contain 200.0±0.2 mL at 20° C. The calibration mark is on the upper stem at least 15 mm below the barrel of the stopcock and completely encircles the stem.

A receiver is constructed from standard-wall, chemically resistant glass tubing having an internal diameter of 50.0±0.8 mm, with one end constricted and sealed to a straight-bore, solid-plug, standard-taper No. 6 stopcock having a 6-mm bore and 12-mm stems. The receiver has three calibration marks completely encircling the tube. The first mark is at the 50-mL point, measured with the stopcock closed and not on any curved portion of the constriction. The second mark is at the 250-mL point, and the third mark is at a distance of 90.0±0.5 cm above the 50-mL mark. The receiver tube is mounted in a standard-wall tubular water jacket having an external diameter of not less than 70 mm, fitted with inlet and outlet connections. The jacket may be attached to the receiver with rubber stoppers or may be sealed at the top and bottom. The seal at the bottom is as close to the barrel of the stopcock as practicable. The assembled receiver and jacket are mounted securely in a plumb position and the jacket is connected to a source of water thermostatically maintained at 48.0±0.5° C. for circulating through the jacket. At the top of the receiver there shall be a platform, flush with the top of the assembly, having a metal plate in which is drilled three indexing holes circumferentially placed around the receiver and having an angular displacement of 120° from each other. A clamp, which may be securely attached to the upper part of the pipette, fits into the holes. The clamp has three leveling screws and lock nuts and, when properly mounted, exactly centers the pipette in the receiver to bring the lower tip of the pipette level with the upper calibration mark on the receiver. A meter stick is fastened to the side or behind the receiver, with the zero point being level with the 250-mL calibration point on the receiver.

Distilled water, or water hardness 100 expressed in parts per million of calcium carbonate is used in tests. The water is preheated to 30±2° C. Then, 500 mL of water is added to 10 g of detergent composition while stirring vigorously. The stiffing is continued until miscibility of the detergent composition in the water is complete. The resulting solution then is aged at 30±2° C. for a total period of 30 min counted from the time when the detergent composition first is added to the water.

While the detergent solution is aging, the water is circulated at 30±2° C. through the water jacket of the receiver, so as to bring the solution to the proper temperature. The walls of the receiver are washed with distilled water and, to verify cleanliness, the draining of water is observed to note whether it is an unbroken film. At the completion of the aging period the stopcock is closed at the bottom of the receiver. The walls of the receiver are rinsed with 50 mL of the detergent solution, using a pipette, and after the rinse drains to the bottom of the receiver, the stopcocks are adjusted so that the level of the solution in the receiver is exactly at the 50-mL mark. The pipette is filled with the detergent solution to the 200-mL mark, using a slight suction. Immediately, the pipette is place in position at the top of the receiver, and the stopcock is opened. When all of the detergent solution has run out of the pipette, a stopwatch is started, and a reading of foam height is taken. A second reading of foam height is taken at the end of 5 minutes. The reading is taken by measuring the foam production at the top of the foam column at the highest average height to which the rim of the foam has reached. This height is proportional to the volume of air remaining in the foam.

### Measurement of Lathering Index

Water, sebum, and a detergent composition are added into a vessel to form a solution, and the vessel is agitated from 500 rpm to 2000 rpm, typically at 1000 rpm. Lather is generated within agitation cycles at approximate intervals of 10 seconds. At the end of the 10 seconds, the rotor is stopped and a Cognex camera images the lather inside the vessel. This process is repeated with another 10 seconds of agitation and imaging until the program is finished, which is typically 12 times at 10 second intervals each for a foam profile of 120 seconds total and 12 data points (not including initial 0).

The 12 discrete data points indicate the height in mm of lather found at each successive 10-second interval. The first point is always 0, with the next number being the value at the 10 second mark. All test materials are indexed against two controls: a high-lather control and a low-lather control. The index sets the high-lather control's lather volume equal to 1 and the low-lather control's lather volume equal to 0. This permits comparison of lather-volume results from day to day, which can be affected by changes in ambient temperature and general environmental differences. The sample lathering index is computed according to the equation L=(V_{S}−V_{L})/(V_{H}−V_{L}), where L is the sample lathering index, V_{S} is the volume of the test sample, V_{L} is the volume of the low-lathering control, and V_{H} is the volume of the high-lathering control. Alternatively, a sample lathering index may be expressed as a ratio of the lathering heights of the test sample and one of the controls. For example, a lathering index to the high-lather control may be expressed as V_{S}/V_{H}, and a lathering index to the low-lather control may be expressed as V_{S}/V_{L}, all variables being defined as above.

The low-lather control and the high-lather control may have the compositions described in TABLE 1:

TABLE 1
Lather Control Compositions

| | Low-Lather Control | High-Lather Control |
|---|---|---|
| Polymer LR400 [1] | 0.50 | |
| Polymer JR30M [2] | | 0.1 |
| Sodium Laureth Sulfate (SLE₃) [3] | | 53.57 |
| Sodium Lauryl Sulfate [4] | | 17.24 |
| Ammonium Laureth Sulfate (ALE₃S) [5] | 35.71 | |
| Ammonium Lauryl Sulfate [6] | 20.69 | |
| Dimethicone Emulsion [7] | 2.55 | |
| Cocamide MEA [8] | 0.94 | |
| PPG-2 Hydroxyethyl Coco/Isostearamide [9] | | 2.0 |
| Ethylene Glycol Distearate [10] | 1.5 | |
| Hydrogenated Polydecene [11] | 0.3 | |
| Trimethylolpropane Tricaprylate/Tricaprate [12] | 0.1 | |
| Sodium Chloride [13] | As needed to thicken to | As needed to thicken to |
| | 5K-10K mPa·s | 5K-10K mPa·s |
| Fragrance | 0.55 | 0.55 |
| Preservatives, pH adjusters | <1.0 | <1.0 |
| Water | Balance to 100.0 | Balance to 100.0 |

[1] Ucare Polymer LR400, MW = 400K, charge density = 0.7 meq/grams, supplier Dow Chemicals
[2] Ucare Polymer JR30M, MW = 2.0MM, charge density = 1.2 meq/gram, supplier Dow Chemicals
[3] Sodium Laureth Sulfate at 28% active with an average of approximately 3 moles of ethoxylation, supplier: P&G
[4] Sodium Lauryl Sulfate at 29% active, supplier: P&G
[5] Ammonium Laueth Sulfate, 25% active with 3 moles of ethoxylation, supplier: P&G
[6] Ammonium Lauryl Sulfate, 25% active, supplier: P&G
[7] Dimethicone Fluid, Viscasil 330M; 70% active in ALE3S; 30 micron particle size; supplier: Momentive Silicones for the 330M & P&G for the emulsion blend
[8] Monamide CMA, 85% active supplier Unichema
[9] Promidium 2, 100% active, supplier Unichema
[10] Ethylene Glycol Distearate, EGDS Pure, supplier Goldschmidt Chemical
[11] Puresyn 6, 100% active, supplier Exxon Mobile Chemical Co.
[12] Puresyn 3e20, 100% active, supplier Exxon Mobile Chemical Co.
[13] Sodium Chloride USP (food grade), supplier Morton.

### Measurement of Phase Separation

To test a composition for phase separation, the composition is loaded into a Beckman polyallomer centrifuge tube until the combined weight of the tube and the composition is 13.5±0.02 g. Six tubes with equal weights of different compositions are placed in rotor buckets and placed on the rotor. The rotor is placed into the vacuum chamber. The rotor is placed under vacuum and the compositions are spun at 40,000 rpm for 16 hrs at 25° C. At the end of 16 hours, the tubes are removed and examined for separation. When separation is detected, the length of the total composition in the tube is measured. The length of each phase is measured. The length of the longest phase is subtracted from the entire length of the composition in the tube and then the result is divided by the entire length of the composition and multiplied by 100 to compute the % phase volume of the phase separation. Formulas are considered stable if the % phase volume is at or below 5%.

### Examples 1 and 2

### Liquid Multipurpose Detergent Compositions

The following compositions in TABLE 2 are prepared by methods known to one of ordinary skill. These compositions represent multipurpose detergent compositions according to the present invention, and the person of ordinary skill readily will recognize these compositions to be non-limiting.

TABLE 2
Multipurpose Detergent Compositions

| Component | Purpose | Example 1 | Example 2 |
|---|---|---|---|
| Neutralized C 11.8 linear alkyl | Anionic Surfactant/Cleaning | 8.0 | NIL |
| benzene sulfonic acid | | | |
| Neodol 23-9 | Non-ionic Surfactant/Cleaning | 3.0 | NIL |
| (C₁₂-C₁₈ alkyl ethoxylate) | | | |
| Laureth sulfate (EO1) | Anionic Surfactant/Cleaning | NIL | 9.0 |
| Lauryl sulfate | Anionic Surfactant/Cleaning | NIL | 3.0 |
| Total Surfactant | | 11.0 | 12.0 |
| Acetic Acid | Acidulant/ Mild | 2.0 | 0.5-1.0 |
| Formic Acid | Preservative | 0.1 | 0.1 |
| Diethylene triamine | Chelant | 0.2 | 0.2 |
| pentaacetic acid (DTPA) | | | |
| Perfume | Aesthetics | 0.1-1.0 | 0.1-1.0 |
| Minors/ Water | | Balance to | Balance to |
| | | 100.0 | 100.0 |
| Property | | A | B |
| Neat pH | | 2-6 | 2-6 |
| Stability | | Stable | Stable |
| Foam Height at 5 min (mm) | | 150 ± 10 | 168 ± 3 |
| Lathering Index to Low-Lather | | 85% | 140% |
| Control | | | |
| Lathering Index to High-Lather | | 59% | 98% |
| Control | | | |
| Optical Transmittance | 425 nm | 91.2% | 98.7% |
| | 450 nm | 93.5% | 98.8% |
| | 480 nm | 95.8% | 99.2% |
| | 500 nm | 97.0% | 99.6% |
| | 540 nm | 98.1% | 99.8% |
| | 600 nm | 99.1% | 100.1% |
| | 640 nm | 99.9% | 100.4% |

Though particular embodiments of the present invention have been illustrated and described, it would be obvious to those skilled in the art that various other changes and modifications can be made without departing from the spirit and scope of the invention. Therefore, the appended claims are intended to cover all such changes and modifications that are within the scope of this invention.

“The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

“Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.”

“While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.”

What is claimed is:

1. A multipurpose detergent composition comprising:
(a) from about 5% to about 25% by weight, based on the weight of the multipurpose detergent composition, of a surfactant system comprising:
(i) from about 20% to about 100% by weight, based on the weight of the surfactant system of at least one anionic surfactant,
wherein no more than about 12% by weight of the overall multipurpose detergent composition comprises anionic surfactants having more than 14 carbon atoms;
(ii) from about 0.04% to about 40% by weight, based on the weight of the surfactant system of an ethoxylated nonionic surfactant; and
(b) from about 0.5% to about 5% by weight, based on the weight of the multipurpose detergent composition, of at least one organic acid, each organic acid in the multipurpose detergent composition having fewer than 9 carbon atoms,
whereby:
the multipurpose detergent composition has a neat pH of from about 2 to about 7;
the multipurpose detergent composition is substantially free of cationic surfactants, zwitterionic surfactants, and amphoteric surfactants;
the multipurpose detergent composition is substantially free of enzymes; and
the multipurpose detergent composition if substantially free of soil suspension polymers and soil release polymers.

2. The multipurpose detergent composition of claim 1, wherein each organic acid in the multipurpose detergent composition has fewer than 6 carbon atoms.

3. The multipurpose detergent composition of claim 1, wherein the multipurpose detergent composition comprises from about 8% to about 15% by weight, based on the weight of the multipurpose detergent composition, of the at least one anionic surfactant.

4. The multipurpose detergent composition of claim 1, wherein the surfactant system consists essentially of a linear alkyl benzene sulfonic acid and a C₁₂-C₁₈ alkyl ethoxylate.

5. The multipurpose detergent composition of claim 4, wherein the linear alkyl benzene sulfonic acid is a C11.8 linear alkyl benzene sulfonic acid.

6. The multipurpose detergent composition of claim 1, wherein the surfactant system consists essentially of ethoxylated laureth sulfate and lauryl sulfate.

7. The multipurpose detergent composition of claim 1, wherein the at least one organic acid comprises acetic acid, formic acid, or mixtures thereof.

8. The multipurpose detergent composition of claim 1, wherein the multipurpose detergent composition has a transmittance of at least 5% at 500 nm.

9. The multipurpose detergent composition of claim 1, wherein the multipurpose detergent composition has an eye irritation comparable to market shampoo products of at least 0.5 mg/mL.

10. The multipurpose detergent composition of claim 1, wherein the multipurpose detergent composition has an eye irritation comparable to market shampoo products of at least 0.6 mg/mL.

11. The multipurpose detergent composition of claim 1, wherein the multipurpose detergent composition has a lathering index to a high-lather control of at least 50%.

12. The multipurpose detergent composition of claim 1, wherein the detergent composition is a liquid multipurpose detergent composition having a viscosity of from about 1 to about 5000 mPa·s.

13. The multipurpose detergent composition of claim 12, wherein the composition is capable of providing a wash water pH, when added to the wash water, of less than 6.5.

14. The multipurpose detergent composition of claim 1, wherein the composition has a pH of less than 6 when diluted by about 700%.

15. The multipurpose detergent composition of claim 1, wherein the composition is substantially free of fatty acid compounds.

16. A method of laundering fabrics which provides reduction of fabric dinginess, said method comprising:
introducing a multipurpose detergent composition of claim 1 into a wash water in an amount sufficient to generate a pH of from about 5 to about 6.5 in the wash water.

17. The method of claim 18, wherein after the detergent composition is introduced into the wash water, the wash water comprises from about 0.02% to about 4.0%, by weight of the wash water, of the detergent composition.

18. A method of laundering fabrics comprising:
pre-treating the fabrics with a pre-treat composition comprising the multipurpose detergent composition of claim 1; and washing the fabrics.

19. The method of laundering fabrics according to claim 20, wherein the pretreating of the fabrics comprises applying the multipurpose detergent composition of claim 1 in its neet form directly to stains on the fabric.
